(19) United States
(12) Patent Application Publication
(10) Pub. No.: US 2024/0281742 A1
(43) Pub. Date: Aug. 22, 2024

(54) GENERATION OF REQUIREMENTS AND WEIGHTAGE SCORES BASED ON A POLICY CONFIGURATION

(71) Applicant: Kyndryl, Inc., New York, NY (US)

(72) Inventors: Avinash Chandra, Bangalore (IN); Veeresh Bushetti, Savanur (IN); Hariharan N. Venkitachalam, Bengaluru (IN); Kalpesh Sharma, Bangalore (IN)

(21) Appl. No.: 18/111,371

(22) Filed: Feb. 17, 2023

(51) Int. Cl. G06Q 10/0637; G06Q 30/0202

(52) U.S. Cl. CPC G06Q 10/06375; G06Q 30/0202

(57) ABSTRACT

In one general embodiment, a computer-implemented method includes collecting information relating at least to market trends and problem ticketing. The collected information is stored in a knowledge repository. At least some of the collected information is processed to compute weightage scores for requirements specified in a policy configuration. A list comprising at least some of the requirements and indications of the weightage scores corresponding thereto is generated and output.

### BACKGROUND

The present invention relates to providing a weighted view of requirements considering various dimensions in an automated manner using a policy driven approach, and more specifically, this invention relates to providing a weighted view of requirements considering various dimensions in an automated manner using a policy driven approach, providing a consolidated view of market trends and opportunities in terms of technology selections, processes, tools and skills in order to build offerings and/or to modernize end to end operations.

Success of a software and other products depends upon various factors such as business need, user feedback/requirement, current and future market trends, etc. Enterprise software development takes time to complete, and there is a high probability that the technology may not stay current, or a change in market trends will occur over time.

In current scenarios, organizations heavily rely on a manual capacity to assess any new plans in context with consumable market insights, in order to establish a business plan. Research reports consumed for this effort may not be comprehensive enough to deal with all possible aspect of failure or success. Moreover, these efforts are prone to human error, and often lead to absolute failure in the worst cases.

There is need for a system to help establish a niche play for a better alignment of strategy, predictable return on investment (ROI), success of the offerings, and ensuring market trends are followed in all the possible operations and executions, be it offering development or infrastructure services. No system can currently predict the features of modernized infrastructure services or where a particular offering will stand in next five years with respect to technology moves and competitive advantages. With the blurring of the lines between different fraternities, all of the work these days falls to the design enabled Software Engineering roles who handle end to end execution, e.g., development, quality assurance (QA), operations, data privacy, etc. Unfortunately, humans can only do so much, cannot retain and analyze vast amounts of data, are prone to error, and results are heavily subjective to the knowledge that lies with the individual who leads the strategy.

### SUMMARY

A computer-implemented method, in accordance with one embodiment, includes collecting information relating at least to market trends and problem ticketing. The collected information is stored in a knowledge repository. At least some of the collected information is processed to compute weightage scores for requirements specified in a policy configuration. A list comprising at least some of the requirements and indications of the weightage scores corresponding thereto is generated and output.

A computer program product, in accordance with one embodiment, includes a computer readable storage medium having program instructions embodied therewith, the program instructions executable by a computer to cause the computer to perform the aforementioned method.

A system, in accordance with one embodiment, includes a hardware processor, and logic integrated with the processor, executable by the processor, or integrated with and executable by the processor, the logic being configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one embodiment of the present invention.

FIG. 2 is a diagram of a representative hardware environment that may be associated with the servers and/or clients of FIG. 1, in accordance with one embodiment of the present invention.

FIG. 3 is a flowchart of a method, in accordance with one embodiment of the present invention.

FIG. 4 is a representation of an architecture for generating a list of requirements with weightage scores, in accordance with one embodiment.

FIG. 5 is a representation of an architecture for generating a list of requirements with weightage scores, in accordance with one embodiment.

FIG. 6 is a representation of portion of a data source for backlog stories, in accordance with one embodiment.

FIG. 7 is a representation of portion of a data source for epics, in accordance with one embodiment.

FIG. 8 is a representation of an illustrative list of requirements with weightage scores, in accordance with one embodiment.

FIG. 9 is a representation of an illustrative list of requirements with weightage scores, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for learning and assimilating domain specific knowledge into a knowledge repository through enterprise sources and prevailing market trends; for processing information from the knowledge repository to produce a list of requirements along with weighted scores; and/or for applying learnings from the knowledge repository to further enhance a policy configuration that specifies the policies of the various methods.

In one general embodiment, a computer-implemented method includes collecting information relating at least to market trends and problem ticketing. The collected information is stored in a knowledge repository. At least some of the collected information is processed to compute weightage scores for requirements specified in a policy configuration. A list comprising at least some of the requirements and indications of the weightage scores corresponding thereto is generated and output.

In another general embodiment, a computer readable storage medium has program instructions embodied therewith, the program instructions executable by a computer to cause the computer to perform the aforementioned method.

In yet another general embodiment, a system includes a hardware processor, and logic integrated with the processor, executable by the processor, or integrated with and executable by the processor, the logic being configured to perform the foregoing method.

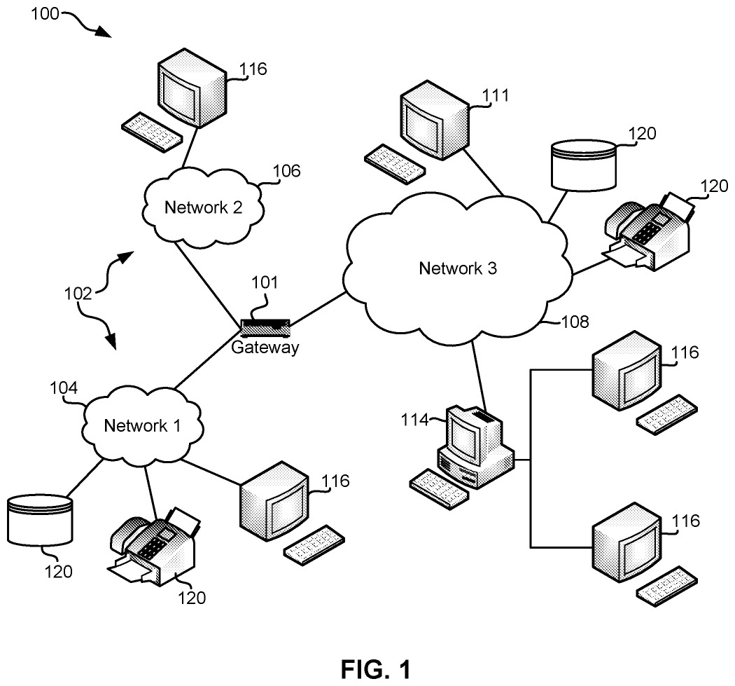

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment (IBM and all IBM-based trademarks and logos are trademarks or registered trademarks of International Business Machines Corporation and/or its affiliates), a UNIX® system which virtually hosts a known operating system environment, an operating system which emulates an IBM® z/OS® environment, etc. This virtualization and/or emulation may be enhanced through the use of VMware® software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

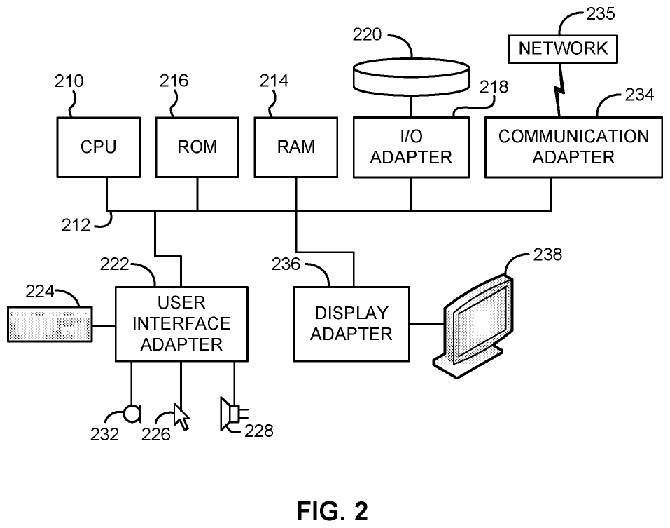

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred embodiment may also be implemented on platforms and operating systems other than those mentioned. A preferred embodiment may be written using extensible Markup Language (XML), C, and/or C++ language, or other programming languages, along with an object oriented programming methodology. Object oriented programming (OOP), which has become increasingly used to develop complex applications, may be used.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

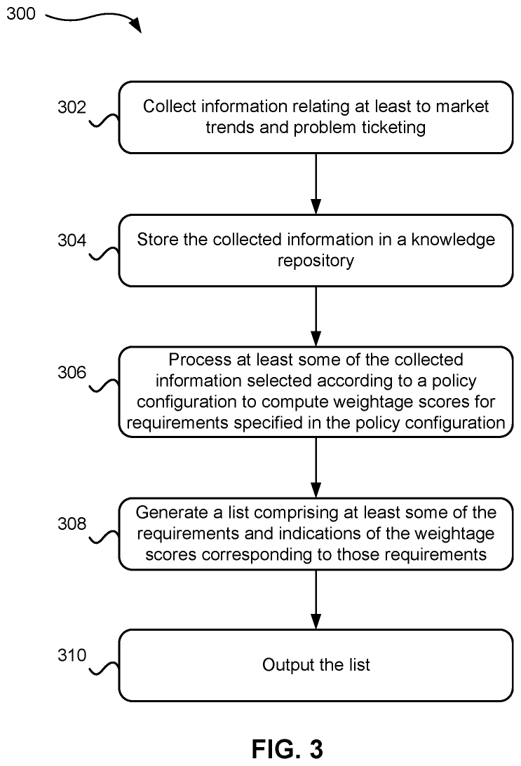

Now referring to FIG. 3, a flowchart of a method 300 is shown according to one embodiment. The method 300 may be performed in accordance with the present invention in any of the environments depicted in FIGS. 1-2 and 4-9, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a system having one or more computers, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where information relating at least to market trends and problem ticketing is collected. Any process for collecting such information that would become apparent to one skilled in the art after reading the present disclosure may be used. Moreover, any type of information may be collected. As described in more detail below, preferred embodiments utilize modules that collect the information from appropriate sources, such as a ticketing tool, the Internet, tools employed by the entity for which the method 300 is being performed, etc.

In preferred embodiments, the information is collected according to a policy configuration, e.g., that specifies which information to collect. The policy configuration may initially be created by a human. Preferably, the policy configuration is updated over time by a machine learning engine that learns from the collected information over time and trains itself to update the policy configuration based on organizational strategy and/or priorities derived from the information. Any process for such machine learning implementation that would become apparent to one skilled in the art after reading the present disclosure may be used. See the description of the policy configuration module and machine learning engine in the exemplary embodiments described below for examples of how a machine learning engine may modify a policy configuration, in accordance with various embodiments.

In one approach, the information relating to market trends is collected by a market trend processor module that collects the market trends information. Preferably, this information is collected according to the policy configuration. The market trend processor module may assign a weightage to each piece of information relating to market trends for storage in the knowledge repository. Examples of such information are provided below in the exemplary embodiments.

In another approach, the information relating to problem ticketing is collected by a keyword processor module that collects the problem ticketing information. Preferably, this information is collected according to the policy configuration. The keyword processor module may assign a weightage to each piece of information relating to problem ticketing for storage in the knowledge repository. In an exemplary embodiment, weightage assigned to each piece of information relating to problem ticketing is based on severity, priority and impact of a problem corresponding to the respective piece of information. Examples of such information are provided below in the exemplary embodiments.

In some approaches, the information collected includes information derived from natural language processing of agile epics of new projects and backlog stories of an entity for which the method is performed. Preferably, this information is collected according to the policy configuration. Examples of such information are provided below in the exemplary embodiments.

In some approaches, the information collected includes skillset information from an expertise management tool of an entity for which the method is performed. Examples of such information are provided below in the exemplary embodiments.

In operation 304, the collected information is stored in a knowledge repository. Any process for storing information that would become apparent to one skilled in the art after reading the present disclosure may be used. Likewise, any type of knowledge base that would become apparent to one skilled in the art after reading the present disclosure may be used.

In operation 306, at least some of the collected information is processed to compute weightage scores for requirements specified in the policy configuration. Requirements may generally be textual descriptions of areas and/or items that an entity should focus on going forward in product development and/or when selecting a direction for the business. For example, requirements may refer to the ask from the end users for the application. Examples include adding ticketing service, add a chatbot, change the color of background, change the title, etc. Thus, the requirements are not, in typical scenarios, anything actually required, but rather are used to provide suggestions of important (higher scored) factors to consider when making product and/or business decisions going forward. For example, in early stages of product development, requirements may suggest problems (issues) to avoid, which domains to focus on, which product features are important to include and/or develop based on market trends, etc. In later stages of product development, requirements may suggest how to automate processes, which ongoing issues are currently most pressing to resolve, whether there are potentially upcoming issues in competing products that should be avoided, etc.

Preferably, at least some of the collected information is selected for processing according to the policy configuration. In preferred embodiments, a data processing engine configured as in the examples below may be used to perform the processing. In one approach, processing the collected information to compute the weightage score for at least some of the requirements includes aggregating individual scores of the pieces of information relevant to the associated requirement. The individual scores may correspond to scores assigned to the information by modules that collected the information. Preferably, the scores assigned to the information by the modules are transformed, based on the policy configuration, into normalized individual scores that are used for the processing. Additional examples of processing the collected information to computer the weightage scores are presented below in the exemplary embodiments.

In operation 308, a list comprising at least some of the requirements and indications of the weightage scores corresponding to those requirements is generated. In preferred embodiments, the aforementioned data processing engine compiles the list.

The list may be created according to the policy configuration. In some approaches, the policy configuration may specify that that the list correspond to a sprint, where a sprint in some approaches is a set period of time during which specific work (e.g., work corresponding to the requirements) should be completed. In other approaches, the policy configuration may specify that that the list correspond to an entire product lifecycle.

In operation 310, the list is output. Any mode of output that would become apparent to one skilled in the art after reading the present disclosure may be used. For example, the list may be output to another process in computer readable form. In another example, the list may be output in human readable form, e.g., in a document, for output on a display, etc.

Preferably, data corresponding to acceptance of the requirements by a human and corresponding weightage scores is fed into the machine learning engine to improve the decision making of the machine learning engine. For example, some or all of the requirements, their scores, and/or the underlying information relating thereto may be fed into the machine learning engine with indications of the human's acceptance, rejection, and/or adjustment of a requirement and/or its score.

Also preferably, the method 300 and others described herein run continuously, periodically, etc. to dynamically update the policy configuration, and accordingly the list, based on newly gathered information, thereby not only improving the list, but ultimately improving the outcome of product development, business focus, etc. For example, various embodiments apply learning dynamically as the processing is done through the data processing engine for computing the requirements as a feedback along with the ability to provide a policy based approach for pre-determined attributes. A policy based configuration allows the methodology presented herein to be applied to any industry verticals with intelligence that can be built by learning on the job or taking a start from initial policy configurations.

### Exemplary Embodiments

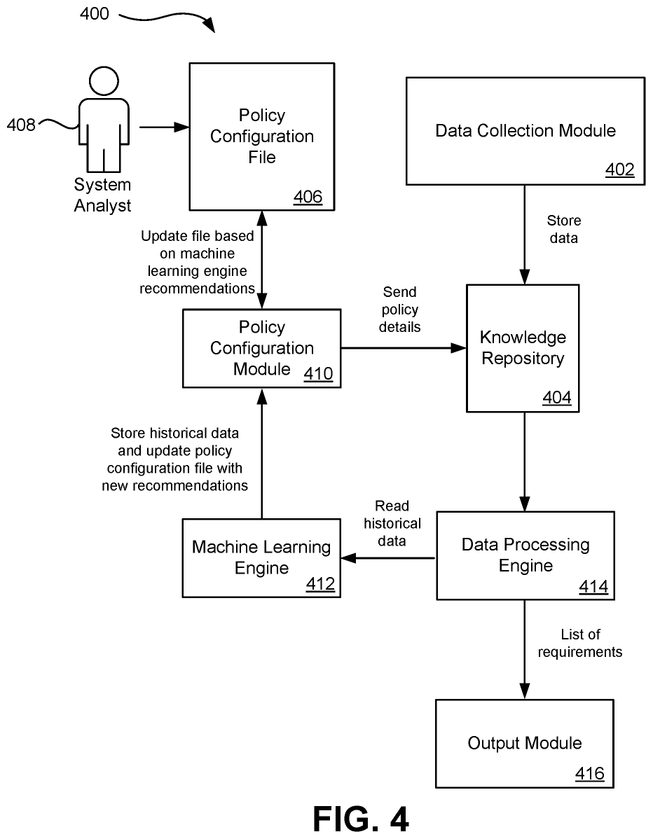

Now referring to FIG. 4, a representation of an architecture 400 for generating a list of requirements with weightage scores is shown according to one embodiment. The process according to the architecture 400 may be performed in accordance with the present invention in any of the environments depicted in FIGS. 1-3 and 5-9, among others, in various embodiments. Of course, more or fewer components than those specifically described in FIG. 4 may be included in architecture 400, as would be understood by one of skill in the art upon reading the present descriptions.

Each of the steps of the method performed according to the architecture 400 may be performed by any suitable component of the operating environment. For example, in various embodiments, the method may be partially or entirely performed by a system having one or more computers, or some other device having one or more processors therein. The processor, e.g., processing circuit(s), chip(s), and/or module(s) implemented in hardware and/or software, and preferably having at least one hardware component may be utilized in any device to perform one or more steps of the method. Illustrative processors include, but are not limited to, a CPU, an ASIC, a FPGA, etc., combinations thereof, or any other suitable computing device known in the art.

As shown in FIG. 4, the architecture 400 includes a data collection module 402, where information is collected. Any process for collecting such information that would become apparent to one skilled in the art after reading the present disclosure may be used. Moreover, any type of information may be collected.

The data collection module 402 preferably includes a plurality of processing modules that are each configured to collect a type of data. Examples of modules that collect information are described in accordance with an exemplary embodiment below.

In the present example, the information collected relates to market trends, problem ticketing, project skillsets, etc. As noted above, parameters such as the sources from which to collect information, the types of information to collect, etc. may be specified in the policy configuration. However, in other approaches, the various modules that collect the information may be individually configured, and/or may operate autonomously to collect information, e.g., via artificial intelligence (AI) that searches for all information relating to the topics and subject matter configured into the AI engine.

The information is stored in a knowledge repository 404, which may be a content store that persists information computed across different processing modules. For example, information relating to problem ticketing may include additional information around severity and impact, ideally with weighted scores of the various production issues reported thus far.

A policy configuration is specified, e.g., in the form of creation of a policy configuration file 406 or in any other form that would become apparent to one skilled in the art upon reading the present disclosure. Creation of the policy configuration may occur before or after operation 402.

In the exemplary process performed by the architecture 400, the policy configuration is initially created by a human 408 such as a system analyst of or working on behalf of an entity for which the method is being performed.

The policy configuration information may include all of the parameters for calculating the list of requirements and their weightage scores. Illustrative parameters include domain names, skills, scores, policies, etc.

A policy configuration module 410 manages the policy configuration, e.g., reads the policy configuration file; updates the policy configuration based on historical data, machine learning engine inputs, etc.; sends the policy configuration or appropriate portions thereof to other components such as the knowledge repository 404, modules that collect the information, etc.; etc.

In a preferred approach, the policy configuration module collects information from a human, e.g., policy configuration settings, an initial policy configuration file, and/or adjustments, which assist in configuration of the other system modules. The resulting policy configuration helps in setting the contexts and boundaries of the system. For example, a system analyst may manually feed the required input parameters such as domain name, skills, scores and policies using a web interface, and these parameters will be stored in a policy configuration file 406. Similarly, the policy configuration may also include another policy for the data processing engine 414, which carries information about weightages across the information available through, within, and outside the enterprise (entity) for which the method is being performed.

As shown, the policy configuration may be updated over time by a machine learning engine 412 that learns from the collected information over time and trains itself to update the policy configuration with new recommendations based on organizational strategy and/or priorities derived from the information. Any process for such machine learning implementation that would become apparent to one skilled in the art after reading the present disclosure may be used. In this example, the machine learning engine receives data, such as historical data, from the data processing engine 414.

Note that the machine learning engine 412 noted above may be deployed in a trained state of a trained AI model. Training of the AI model, in some approaches, may be performed by applying a predetermined training data set to learn how to process the data from the data processing engine 414. Initial training may include reward feedback that may in some approaches be implemented using a subject matter expert (SME) that understands how the data from the data processing engine 414 should be processed with respect to the training data. In another approach, the reward feedback may be implemented using techniques for training a BERT model, as would become apparent to one skilled in the art after reading the present disclosure. Once a determination is made that the AI model achieves a redeemed threshold of accuracy during this training, a decision that the model is trained and ready to deploy for use in the architecture 400.

The machine learning engine 412 may, in some approaches, perform predetermined observing and/or assessing operations defined within an AI reasoning model. In some preferred approaches, the AI reasoning model is a neuro-symbolic AI model. Approaches in which the AI reasoning model is a neuromyotonic AI model may improve performance of computer devices in the architecture 400 because the neuromyotonic AI model may not need a subject matter expert and/or iteratively applied training with reward feedback in order to accurately analyze the deployed policy. Instead, the neuromyotonic AI model is configured to itself make accuracy assessments and alter a policy based on such assessments. Weight values may, in some approaches, be used by the AI reasoning model to analyze information from the data processing engine 414 as it pertains to the deployed policy.

The data processing engine 414 receives data from the knowledge repository 404, and processes the data according to the policy configuration to produce a list of requirements. In one approach, the data processing engine 414 selects information stored in the knowledge repository 404 based on the policy configuration, and processes the data to determine a list of requirements and a weightage score for each requirement. Any known technique for processing the data that would become apparent to one skilled in the art after reading the present disclosure may be adapted for use in the data processing engine 414.

In a preferred approach, the data processing engine 414 processes the information ingested across the various processing modules that collect the information. An overall score is determined in any manner that would become apparent to one skilled in the art upon reading the present disclosure. Preferably, an overall score is determined by aggregating the individual scores computed by the processing modules and further normalized based on the policy configuration related to the data processing engine. The data processing engine 414 then produces a list of requirements with respective weightage scores for relativity.

The list of requirements with respective weightage scores is output by output module 416. The list of requirements may provide a roadmap for future product development and/or for improving end to end operations.

Learning based on the final acceptance of the list by a human may be fed back to the policy configuration module 410, e.g., via the machine learning engine 412.

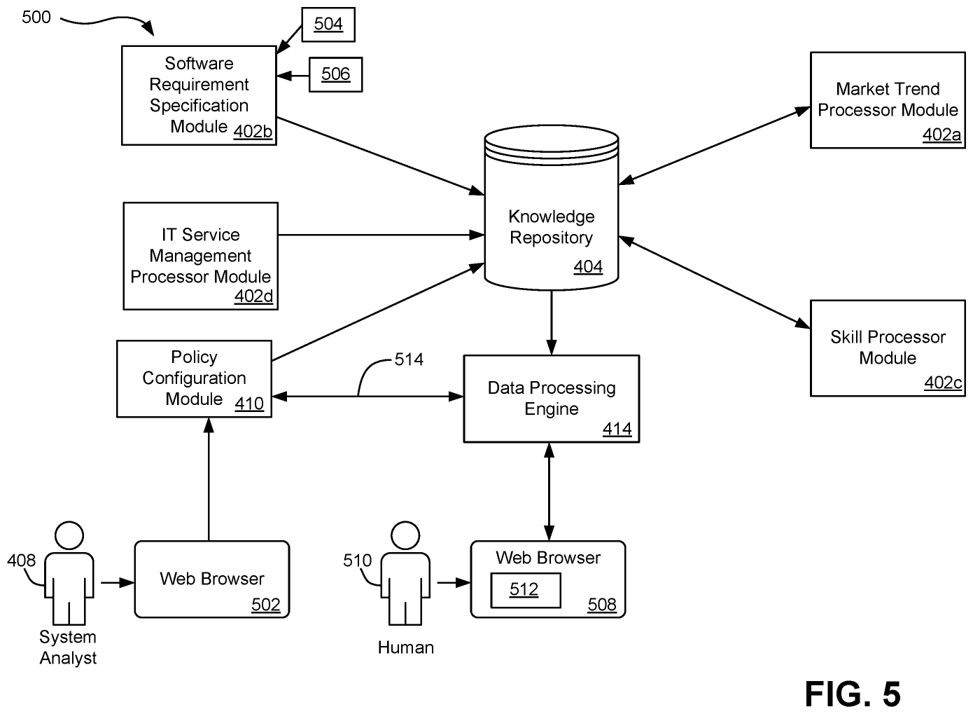

Referring to FIG. 5, a representation of an architecture 500 for generating a list of requirements with weightage scores is shown according to one embodiment. The process according to the architecture 500 may be performed in accordance with the present invention in any of the environments depicted in FIGS. 1-4 and 6-9, among others, in various embodiments. Of course, more or fewer components than those specifically described in FIG. 5 may be included in architecture 500, as would be understood by one of skill in the art upon reading the present descriptions.

Each of the steps of the method performed according to the architecture 500 may be performed by any suitable component of the operating environment. For example, in various embodiments, the method may be partially or entirely performed by a system having one or more computers, or some other device having one or more processors therein. The processor, e.g., processing circuit(s), chip(s), and/or module(s) implemented in hardware and/or software, and preferably having at least one hardware component may be utilized in any device to perform one or more steps of the method. Illustrative processors include, but are not limited to, a CPU, an ASIC, a FPGA, etc., combinations thereof, or any other suitable computing device known in the art.

Note that common elements with FIG. 4 have been numbered as in FIG. 4.

As shown in FIG. 5, the architecture 500 includes a policy configuration module 410, e.g., as described above with reference to FIG. 4, and/or according to any of the embodiments presented herein. In a preferred aspect, the policy configuration nodule 410 is a module that collects information from a human, e.g., system analyst 408, which further will help in configuration of the other modules in the architecture 500. This helps in setting the context and boundaries of the system. For example, the system analyst 408 may manually feed the required input parameters such as domain names, skills, scores and policies using a web interface 502, and this input will be stored in a policy configuration file. Similarly, the system analyst 408 may specify another policy for the data processing engine 414, which carries information about weightages across the information available through, within, and outside the enterprise (entity) for which the method according to the architecture 500 is being performed.

As shown in FIG. 5, several modules 402a-402d collect information from within and outside organization, preferably from a discrete set of data sources related to a business domain. The set of data sources may be predefined, specified by the policy configuration, etc.

Each module 402a-402d will be described in turn below. Note that any number of modules may be present, for example, additional modules for collecting other types of information. Moreover, some or all of the modules may operate according to one or more of a configuration applied thereto by a human, according to parameters and specified domains in the policy configuration, etc. For example, the domains searched may be configured in the policy configuration module 410 and passed as an input parameter by a human, e.g., the system analyst.

Module 402a is a market trend processor module that searches data sources for information about market trends, areas of high revenue, areas projected to be in demand, what a competitor is doing, etc. In one approach, APIs to online search engines are used to search websites, databases, etc., e.g., to collect information about ongoing market trends such as AI, blockchain, responsive websites, data science, etc. Illustrative APIs include APIs to Gartener, Forester and Google Trends products. In another approach, the market trend processor module 402a may use an AI natural language understanding processor such as the IBM Watson Natural Language Understanding tool to search data sources for relevant information. Moreover, the market trend processor module 402a may create an estimate of how much money sales of a product could make.

This module 402a preferably does not just assimilate the information about the strategic trends, but will also help provide weightage for each of the focused strategic elements collected thereby. The output of this module is provided to the knowledge repository 404.

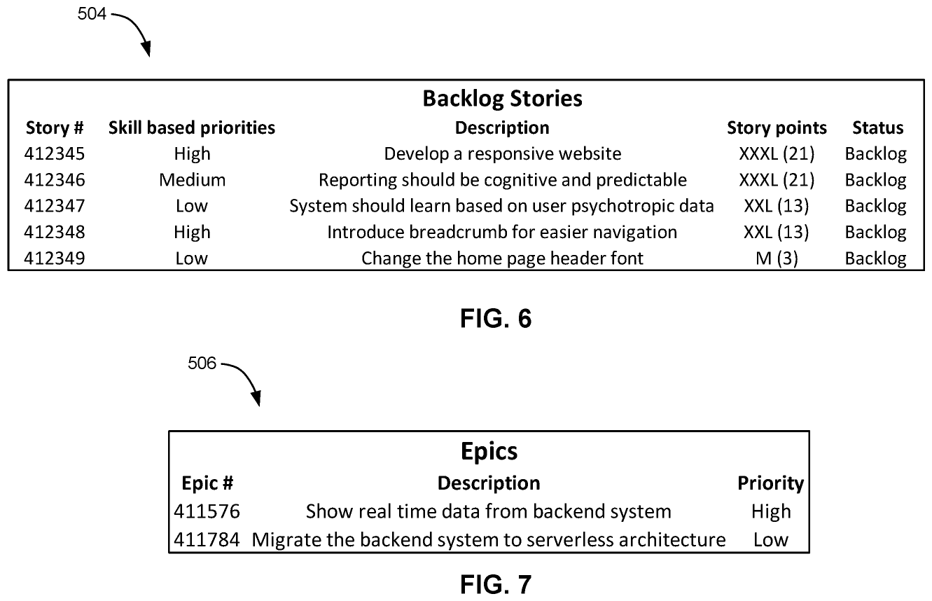

The software requirement specification processor 402b is preferably a configurable module which is an inwards focused computing module that consumes information available across various tools used by an agile-type development, and ingests the as is prioritized stories to the knowledge repository. For example, an AI natural language understanding processor may be used to process epics 506 for new projects and backlog stories 504. FIG. 6 illustrates a representation of portion of a data source for backlog stories 504. FIG. 7 illustrates a representation of portion of a data source for epics 506.

An epic may generally refer to a body of work that can be broken down into specific tasks (called user stories) based on the needs/requests of customers or end-users. Epics are a helpful way to organize work and to create a hierarchy, e.g., by breaking a large work task down into smaller pieces so they are more manageable and portions of the overall project can be assigned more easily.

The skill processor module 402c is preferably a configurable module which consumes inputs from an expertise management tool hosted within the enterprise. The expertise management tool may characterize the skills available in the workforce of the entity, identify skills that are not adequately provided by the workforce, etc. The skill processor module 402c may process available information, normalize said information, and feed the normalized information into the knowledge repository 404. The skills searched for may be specified by the system analyst, policy configuration, etc. Illustrative skills include Java/J2EE, Angular 4, Python, Mongo DB, Shell Script, AI, machine learning, cloud computing, etc.

The internet technology service management processor module 402d collects information about ticketing issues, such as production bugs, customer complaints, etc. For example, the internet technology service management processor module 402d may receive inputs such as tickets, announcements, etc. from the operating environment of the entity or product on a day to day basis.

Preferably, the internet technology service management processor module 402d uses an AI natural language understanding processor to process some, and preferably all, of the service management and future currency upgrade-related issues in terms of the severity, priority and/or impact details of each issue. The data is further ingested into the knowledge repository, preferably with the weighted scores of various issues. For instance, the module 402d may collect defects from all environments and rank each defect based on weightages of the different environments. For example, a production environment could have the highest weightage, while servicing has the lowest weightage.

The data processing engine module 414 processes the information ingested across different modules such as modules 402a-402b. Preferably, an overall score is determined by aggregating the individual scores computed by the processing modules and further normalized based on the policy file related to the data processing engine. The data processing engine module 414 produces a list of requirements with respective weightage scores for each listed requirement. Note that the list may not include all possible requirements, but rather only those requirements meeting some criterion, such as the highest weightage.

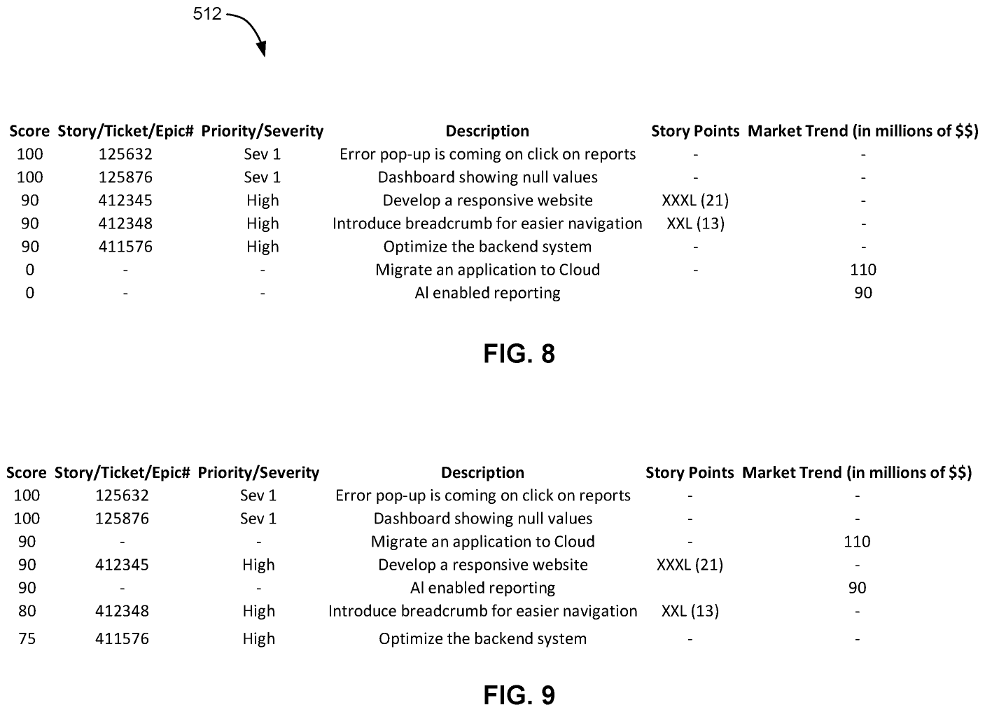

The list 512 may be output to a web browser 508 for viewing by a human 510, e.g., the system analyst, an employee of the enterprise, etc. FIG. 8 depicts an illustrative list 512 that may be output. The items in each line of the list may collectively be considered a requirement, or in some approaches, only a portion of the items in the list is considered a requirement. In the exemplary list 512 shown, the list includes the weightage score; an identifier of the story, ticket or epic; the priority or severity of the story, ticket or epic; a description of the requirement; whether there are any story points; and projected potential revenue of a feature of or improvement to the product or service for which the list 512 is created. Note that the projected potential revenue may be output in terms of the product/service alone, and/or in terms of the revenue in the market in general.

As in the example of FIG. 4, learning based on the final acceptance, by a human 510, of the list and/or the weightages assigned to the requirements may be fed back to the policy configuration module 410, as exemplified by arrow 514.

The effect of such feedback on the policy configuration and resulting list is exemplified with reference to the lists of FIGS. 8 and 9. Initially, when the policy configuration is empty, assume a default parameter in the policy configuration file is as follows:

```
{
  “productionBug”: 100,
  “story”: 90
}
```

As per the default policy configuration above, the draft list requirements and weightages (collectively, the roadmap) appear as in FIG. 8, reflecting the market trends as discovered but not prioritized or aligned to particular organizational needs. Over a period of time, the machine learning engine 412 learns from the incoming data and execution history, and trains itself to update policy and align the prioritization based on the organizational strategy and/or priorities. This learning can be expedited by initial intervention from a human in terms of updates to the policies.

An example of an updated policy configuration follows. Assume a search for “AI” is made according to the following policy configuration.

```
{
        “marketTrend”: [
      {
    “AI & ML” : 9 on scale of 10,
    “range”: “>100 million”,
    “score” 90
      },
      {
    “Data Science” : 7 on scale of 10,
    “range”: “>= 50 million and <= 100 million”,
    “score” 80
      }
  ],
  “productionBug”: 100,
  “story”: {
    “high”: 100,
    “medium”: 90,
    “low”: 80
  },
  “epic”: {
    “high”: 100,
    “medium”: 90,
    “low”: 80
  },
  “skills”:[“Data Science”, “Responsive UI”]
}
```

The policy configuration file above and raw data from all sources is fed into the data processing engine, a score is calculated, and based on the score, the top several requirements are considered for a sprint. The corresponding output is shown in FIG. 9.

### BENEFITS AND PRACTICAL APPLICATIONS

The foregoing methodologies provide many practical applications. For example, as noted above, by transforming information about issues, market trends, etc. into a list of requirements with weightage scores, the requirements that matter most are identified and can be used to build offerings and/or to modernize end to end operations. In this way, for example, product management can be made more intelligent and more system driven based on the awareness of market trends and product issues newly-enabled by various embodiments.

The analysis of information and dynamic evolution of the policy configuration to create the list of requirements with weightage scores could not practically be performed by a human. Rather, the architectures presented herein according to various embodiments are computer based, and do receive input from a human that affects the data collection and data processing in such embodiments.

Moreover, by updating a policy configuration by applying both human input and execution history data to a machine learning engine, the overall effectiveness and accuracy of the computer-based architectures described herein are improved to produce better, more pertinent results. In addition, the disclosed feedback mechanism and policy based approach allows various embodiments to continuously learn and adapt to improve the overall confidence of the weighted scores.

The foregoing methodologies, while rooted in data collection, convey an improvement in another technology, namely business analysis and planning, by improving the functionality, reliability, effectiveness, and efficiency of business analysis and planning.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting information relating at least to market trends and problem ticketing;
storing the collected information in a knowledge repository;
processing at least some of the collected information to compute weightage scores for requirements specified in a policy configuration;
generating a list comprising at least some of the requirements and indications of the weightage scores corresponding thereto; and
outputting the list.

2. The computer-implemented method of claim 1, wherein the information is collected according to the policy configuration.

3. The computer-implemented method of claim 1, wherein the policy configuration is initially created by a human, wherein the policy configuration is updated over time by a machine learning engine that learns from the collected information over time and trains itself to update the policy configuration based on organizational strategy and/or priorities derived from the information.

4. The computer-implemented method of claim 3, wherein data corresponding to acceptance of the requirements by a human and corresponding weightage scores is fed into the machine learning engine.

5. The computer-implemented method of claim 1, wherein the information relating to market trends is collected by a market trend processor module that collects the market trends information according to the policy configuration, wherein the market trend processor module assigns a weightage to each piece of information relating to market trends for storage in the knowledge repository.

6. The computer-implemented method of claim 1, wherein the information relating to problem ticketing is collected by a keyword processor module that collects the problem ticketing information according to the policy configuration, wherein the keyword processor module assigns a weightage to each piece of information relating to problem ticketing for storage in the knowledge repository.

7. The computer-implemented method of claim 6, wherein the weightage assigned to each piece of information relating to problem ticketing is based on severity, priority and impact of a problem corresponding to the respective piece of information.

8. The computer-implemented method of claim 1, wherein the information collected includes information derived from natural language processing of agile epics of new projects and backlog stories of an entity for which the method is performed.

9. The computer-implemented method of claim 1, wherein the information collected includes skillset information from an expertise management tool of an entity for which the method is performed.

10. The computer-implemented method of claim 1, wherein processing the collected information to compute the weightage score for at least some of the requirements includes aggregating individual scores of pieces of the information relevant to the associated requirement, wherein the individual scores correspond to scores assigned to the information by modules that collected the information.

11. The computer-implemented method of claim 10, wherein the scores assigned to the information by the modules are transformed, based on the policy configuration, into normalized individual scores that are used for the processing.

12. A computer program product, the computer program product comprising a computer readable storage medium having program instructions embodied therewith, the program instructions executable by a computer to cause the computer to perform a method comprising:
collecting, by the computer, information relating at least to market trends and problem ticketing;
storing, by the computer, the collected information in a knowledge repository;
processing, by the computer, at least some of the collected information to compute weightage scores for requirements specified in a policy configuration;
generating, by the computer, a list comprising at least some of the requirements and indications of the weightage scores corresponding thereto; and
outputting, by the computer, the list.

13. The computer program product of claim 12, wherein the information is collected according to the policy configuration.

14. The computer program product of claim 12, wherein the policy configuration is initially created by a human, wherein the policy configuration is updated over time by a machine learning engine that learns from the collected information over time and trains itself to update the policy configuration based on organizational strategy and/or priorities derived from the information.

15. The computer program product of claim 12, wherein the information relating to market trends is collected by a market trend processor module that collects the market trends information according to the policy configuration, wherein the market trend processor module assigns a weightage to each piece of information relating to market trends for storage in the knowledge repository.

16. The computer program product of claim 12, wherein the information relating to problem ticketing is collected by a keyword processor module that collects the problem ticketing information according to the policy configuration, wherein the keyword processor module assigns a weightage to each piece of information relating to problem ticketing for storage in the knowledge repository.

17. The computer program product of claim 12, wherein the information collected includes information derived from natural language processing of agile epics of new projects and backlog stories of an entity for which the method is performed.

18. The computer program product of claim 12, wherein the information collected includes skillset information from an expertise management tool of an entity for which the method is performed.

19. The computer program product of claim 12, wherein processing the collected information to compute the weightage score for at least some of the requirements includes aggregating individual scores of pieces of the information relevant to the associated requirement, wherein the individual scores correspond to scores assigned to the information by modules that collected the information.

20. A system, comprising:
a hardware processor; and
logic integrated with the processor, executable by the processor, or integrated with and executable by the processor, the logic being configured to:
collect information relating at least to market trends and problem ticketing;
store the collected information in a knowledge repository;
process at least some of the collected information to compute weightage scores for requirements specified in a policy configuration;
generate a list comprising at least some of the requirements and indications of the weightage scores corresponding thereto; and
output the list.
